(19) United States
(12) Patent Application Publication
(10) Pub. No.: US 2026/0332976 A1
(43) Pub. Date: Oct. 22, 2026

(54) AUDIO SYSTEM PARAMETER CONFIGURATION METHOD, APPARATUS, DEVICE, AND STORAGE MEDIUM

(71) Applicant: Linkplay Technology Inc., Newark, CA (US)

(72) Inventors: Ning LIU, Newark, CA (US); Lifeng ZHAO, Newark, CA (US); Qi WANG, Newark, CA (US)

(73) Assignee: Linkplay Technology Inc., Newark, CA (US)

(21) Appl. No.: 19/381,011

(22) Filed: Nov. 6, 2025

(30) Foreign Application Priority Data
Apr. 22, 2025 (CN) 202510502771.9

(51) Int. Cl. H04S 7/00; G06F 3/16; H04R 5/02; H04R 5/04

(52) U.S. Cl. CPC H04S 7/301; G06F 3/162; H04R 5/02; H04R 5/04; H04S 2400/13; H04S 2400/15

(57) ABSTRACT

An audio system parameter configuration method includes: obtaining a type of a current input signal source and audio format information; identifying, based on the type of the input signal source and the audio format information, an audio content type and determining an optimal playback mode; adjusting, based on the optimal playback mode, a speaker combination and a channel configuration of the audio system; and determining a volume level according to the audio content type, and performing adaptive volume level adjustment for the audio system based on the volume level, a user preference and environmental analysis.

### CROSS-REFERENCE TO THE RELATED APPLICATIONS

This application is based upon and claims priority to Chinese Patent Application No. 202510502771.9, filed on Apr. 22, 2025, the entire contents of which are incorporated herein by reference.

### TECHNICAL FIELD

This application relates to the field of audio system parameter configuration technologies, in particular to an audio system parameter configuration method, an audio system parameter configuration apparatus, an electronic device and a storage medium.

### BACKGROUND

In the prior art, the parameter configuration manner for an audio system is typically as follows: in terms of channel configuration, it directly configures sound channels of speakers based solely on the audio format of the input signal source; in terms of volume configuration, it relies on simple ambient noise detection for volume adjustment. Because this existing parameter configuration manner for the audio system overlooks the inherent characteristics of the audio itself during channel configuration, and considers only a single factor without comprehensively integrating other relevant factors during volume configuration, this configuration manner cannot adapt to different audio contents and diversified scenarios, resulting in insufficiently accurate configuration results.

### SUMMARY

In a first aspect, this application provides an audio system parameter configuration method, including: obtaining a type of a current input signal source and audio format information; identifying, based on the type of the input signal source and the audio format information, an audio content type and determining an optimal playback mode; adjusting, based on the optimal playback mode, a speaker combination and a channel configuration of the audio system; and determining a volume level according to the audio content type, and performing adaptive volume level adjustment for the audio system based on the volume level, a user preference and environmental analysis.

In one possible implementation, obtaining the type of the current input signal source and audio format information includes: detecting the type of the current input signal source through an audio system interface, where the type of the input signal source includes at least one of Bluetooth, Wi-Fi, or wired interface; parsing an audio format of the input signal source; wherein the audio format includes at least one of MP3, Waveform Audio File Format (WAV), Free Lossless Audio Codec (FLAC), and Advanced Audio Coding (AAC); and identifying a sampling rate and bit depth of the input signal source to obtain the audio format information.

In one possible implementation, identifying the audio content type and determining the optimal playback mode based on the type of the input signal source and the audio format information includes: querying, based on the type of the input signal source and the audio format information, a corresponding audio content type in a database; calculating, according to hardware performance of the audio system, a current environmental condition, and a user historical preference, a matching score for each playback mode corresponding to the current audio content type; and selecting a playback mode with the highest matching score as the optimal playback mode.

In one possible implementation, adjusting based on the optimal playback mode the speaker combination and the channel configuration of the audio system includes: analyzing sound effect requirements based on the optimal playback mode, and generating a speaker layout optimization scheme based on the sound effect requirements, a set of speaker performance parameters and spatial acoustic characteristics; adjusting relative positions, angles, and spatial distribution of speakers in the audio system according to the speaker layout optimization scheme; and performing channel configuration based on the adjusted speaker layout and the optimal playback mode.

In one possible implementation, analyzing sound effect requirements based on the optimal playback mode, and generating the speaker layout optimization scheme based on the sound effect requirements, the set of speaker performance parameters and spatial acoustic characteristics includes: analyzing sound-effect feature parameters in the optimal playback mode, determining sound effect requirement indicators based on the sound effect feature parameters; evaluating a matching degree between each sound-effect requirement indicator and the set of speaker performance parameters, and screening the speaker in the audio system based on a matching degree evaluation result to obtain a speaker screening result; obtaining room acoustic feature parameters, where the room acoustic feature parameters include: room dimensions, a shape of a room, reverberation time, a reflection path, a sound absorption coefficient, and sound field distribution; and generating a speaker layout optimization scheme based on the speaker screening result and the room acoustic feature parameters.

In one possible implementation, evaluating the matching degree between the sound-effect requirement indicator and the set of speaker performance parameters, and screening the speaker in the audio system based on the matching degree evaluation result to obtain the speaker screening result includes: collecting a frequency response range, power output capability, and a distortion level of each speaker in the audio system, to obtain the set of speaker performance parameters, where the set of speaker performance parameters includes performance parameters of each speaker; calculating a similarity between each performance parameter of the speaker and the sound-effect indicator to obtain the corresponding matching degree; and excluding a speaker with a matching degree lower than a preset threshold to obtain the speaker screening result.

In one possible implementation, generating the speaker layout optimization scheme based on the speaker screening result and the room acoustic feature parameters includes: setting objective functions for speaker layout optimization based on the speaker screening result and the room acoustic feature parameters; setting constraints based on physical dimensions and installation location of each speaker; performing iterative calculations by using a genetic algorithm under the set objective functions and constraints, determining the optimal locations, angles, and spatial distribution of the speakers, and outputting the speaker layout optimization scheme.

In one possible implementation, adjust the locations, angles, and spatial distribution of the speakers according to the speaker layout optimization scheme includes: controlling an electric adjustment mechanism in the audio system to adjust the relative positions and angles of the speakers according to the speaker layout optimization scheme; determining whether the angle of each speaker is correctly adjusted by using an angle sensor; and verifying whether the adjusted spatial distribution of the speakers meets the requirements of the speaker layout optimization scheme.

In one possible implementation, performing channel configuration based on the adjusted speaker layout and the optimal playback mode includes: determining, based on an acoustic requirement of the optimal playback mode, a correspondence between each sound element and an available audio channel; and assigning, based on the adjusted speaker layout, an audio signal of each channel to the corresponding speaker.

In one possible implementation, determining the volume level according to the audio content type, and performing adaptive volume level adjustment for the audio device based on the volume level, the user preference and environmental analysis includes: obtaining an initial volume parameter matching the audio content type from a preset volume level library; obtaining user historical volume adjustment records from user historical preference data; collecting a noise intensity value, a spatial reverberation parameter, and ambient light intensity data of a current environment to generate an environmental feature vector; and adjusting the initial volume parameter based on the user historical volume adjustment records and the environmental feature vector, and applying the adjusted volume parameter to the audio system.

In one possible implementation, collecting the noise intensity value, the spatial reverberation parameter, and ambient light intensity data of the current environment to generate the environmental feature vector includes: collecting, using the environmental sensor, the noise intensity value, the spatial reverberation parameter, and ambient light intensity data of the current environment; inputting the noise intensity value, the spatial reverberation parameter, and ambient light intensity data of the current environment into a predefined environmental analysis model to obtain the environmental feature vector; where the environmental analysis model is a multimodal data fusion-based machine learning model that, through jointly learning a nonlinear mapping relationship among the noise intensity, spatial reverberation, and light intensity, outputs a normalized environmental feature vector.

In one possible implementation, adjusting the initial volume parameter based on the user historical volume adjustment records and the environmental feature vector includes: calculating an average volume adjustment offset of the user for a same category of audio content type and in a similar environment by using the user historical volume adjustment records; inputting the environmental feature vector into a preset volume compensation regression model, and outputting a corresponding environmental volume compensation coefficient by analyzing a synergistic influence relationship of noise intensity, spatial reverberation, and light intensity; and determining the adjusted volume parameter based on the average volume adjustment offset, the environmental volume compensation coefficient, and the initial volume parameter.

In a second aspect, this application provides an audio system parameter configuration apparatus, including: an obtaining module, configured to obtain a type of a current input signal source and audio format information; an identifying module, configured to identify, based on the type of the input signal source and the audio format information, an audio content type and determining an optimal playback mode; an adjusting module, configured to adjust, based on the optimal playback mode, a speaker combination and a channel configuration of the audio system; and an adjustment module, configured to determine a volume level according to the audio content type, and perform adaptive volume level adjustment for the audio system based on the volume level, a user preference and environmental analysis.

In one possible implementation, the obtaining module is configured to: detect the type of the current input signal source through an audio system interface, where the type of the input signal source includes at least one of Bluetooth, Wi-Fi, or wired interface; parse an audio format of the input signal source; wherein the audio format includes at least one of MP3, Waveform Audio File Format (WAV), Free Lossless Audio Codec (FLAC), and Advanced Audio Coding (AAC); and identify a sampling rate and bit depth of the input signal source to obtain the audio format information.

In one possible implementation, the identifying module is configured to: query, based on the type of the input signal source and the audio format information, a corresponding audio content type in a database; calculate, according to hardware performance of the audio system, a current environmental condition, and a user historical preference, a matching score for each playback mode corresponding to the current audio content type; and select a playback mode with the highest matching score as the optimal playback mode.

In one possible implementation, the adjusting module includes: a first generating unit, configured to analyze sound effect requirements based on the optimal playback mode, and generate a speaker layout optimization scheme based on the sound effect requirements, a set of speaker performance parameters and spatial acoustic characteristics; a first adjusting unit, configured to adjust relative positions, angles, and spatial distribution of speakers in the audio system according to the speaker layout optimization scheme; and a configuration unit, configured to perform channel configuration based on the adjusted speaker layout and the optimal playback mode.

In one possible implementation, the first generating unit includes: a determining subunit, configured to analyze sound-effect feature parameters in the optimal playback mode, and determine sound effect requirement indicators based on the sound effect feature parameters; a screening subunit, configured to evaluate a matching degree between each sound-effect requirement indicator and the set of speaker performance parameters, and screen the speaker in the audio system based on a matching degree evaluation result to obtain a speaker screening result; an obtaining subunit, configured to obtain room acoustic feature parameters, where the room acoustic feature parameters includes: room dimensions, a shape of a room, reverberation time, a reflection path, a sound absorption coefficient, and sound field distribution; and a generating subunit, configured to generate a speaker layout optimization scheme based on the speaker screening result and the room acoustic feature parameters.

In one possible implementation, the screening subunit is configured to: collect a frequency response range, power output capability, and a distortion level of each speaker in the audio system, to obtain the set of speaker performance parameters, where the set of speaker performance parameters includes performance parameters of each speaker; calculate a similarity between each performance parameter of the speaker and the sound-effect indicator to obtain the corresponding matching degree; and exclude a speaker with a matching degree lower than a preset threshold to obtain the speaker screening result.

In one possible implementation, the generating subunit is configured to: set objective functions for speaker layout optimization based on the speaker screening result and the room acoustic feature parameters; set constraints based on physical dimensions and installation location of each speaker; perform iterative calculations by using a genetic algorithm under the set objective functions and constraints, determine the optimal locations, angles, and spatial distribution of the speakers, and output the speaker layout optimization scheme.

In one possible implementation, the first adjusting unit is configured to: control an electric adjustment mechanism in the audio system to adjust the relative positions and angles of the speakers according to the speaker layout optimization scheme; determine whether the angle of each speaker is correctly adjusted by using an angle sensor; and verify whether the adjusted spatial distribution of the speakers meets the requirements of the speaker layout optimization scheme.

In one possible implementation, the configuration unit is configured to: determine, based on an acoustic requirement of the optimal playback mode, a correspondence between each sound element and an available audio channel; and assign, based on the adjusted speaker layout, an audio signal of each channel to the corresponding speaker.

In one possible implementation, the adjustment module includes: a matching unit, configured to obtain an initial volume parameter matching the audio content type from a preset volume level library; an obtaining unit, configured to obtain user historical volume adjustment records from user historical preference data; a second generating unit, configured to collect a noise intensity value, a spatial reverberation parameter, and ambient light intensity data of a current environment to generate an environmental feature vector; and a second adjusting unit, configured to adjust the initial volume parameter based on the user historical volume adjustment records and the environmental feature vector, and apply the adjusted volume parameter to the audio system.

In one possible implementation, the second generating unit is configured to: collect, using the environmental sensor, the noise intensity value, the spatial reverberation parameter, and ambient light intensity data of the current environment; input the noise intensity value, the spatial reverberation parameter, and ambient light intensity data of the current environment into a predefined environmental analysis model to obtain the environmental feature vector; where the environmental analysis model is a multimodal data fusion-based machine learning model that, through jointly learning a nonlinear mapping relationship among the noise intensity, spatial reverberation, and light intensity, outputs a normalized environmental feature vector.

In one possible implementation, the second adjusting unit is configured to: calculate an average volume adjustment offset of the user for a same category of audio content type and in a similar environment by using the user historical volume adjustment records; input the environmental feature vector into a preset volume compensation regression model, and output a corresponding environmental volume compensation coefficient by analyzing a synergistic influence relationship of noise intensity, spatial reverberation, and light intensity; and determine the adjusted volume parameter based on the average volume adjustment offset, the environmental volume compensation coefficient, and the initial volume parameter.

In a third aspect, this application provides an electronic device, including: a memory; and at least one processor; where the memory has stored thereon instructions, and the instructions, when executed by the at least one processor, cause the electronic device to perform the above-mentioned audio system parameter configuration method.

In a fourth aspect, this application provides a computer readable storage medium on which instructions are stored, the instructions are executed by a processor to perform the above-mentioned audio system parameter configuration method.

### BRIEF DESCRIPTION OF THE DRAWINGS

FIG. 1 is a schematic view showing an audio system parameter configuration method according to some embodiments of this application;

FIG. 2 is another schematic view showing the audio system parameter configuration method according to some embodiments of this application;

FIG. 3 is a schematic view showing an audio system parameter configuration apparatus according to some embodiments of this application;

FIG. 4 is another schematic view showing the audio system parameter configuration apparatus according to some embodiments of this application; and

FIG. 5 is a schematic view showing an electronic device according to some embodiments of this application.

### DETAILED DESCRIPTION OF THE EMBODIMENTS

The embodiment of this application provides an audio system parameter configuration method, apparatus, and device, and a storage medium, which improves configuration accuracy by comprehensively considering multiple factors during the parameter configuration process.

Terms such as “first”, “second”, “third” and “fourth” (if any) in the description, claims and the drawings of this application are used to differentiate similar objects, and not necessarily used to describe a specific sequence or order. It should be appreciated that the data used in this way may be interchanged under an appropriate circumstance, so that the embodiments of this application described herein may be implemented in a sequence other than those illustrated or described herein. Moreover, terms “include”, “have” and any other variation thereof are intended to encompass non-exclusive inclusion, such that a process, method, system, product or device including a series of steps or units includes not only those steps or elements, but also other steps or units not explicitly listed, or steps or units inherent in the process, method, system, product or device.

As can be appreciated, an entity for performing this application may be the audio system parameter configuration apparatus, or a terminal, or a server, which will not be particularly defined herein. The embodiments of this application are illustrated with the server as the entity.

It is important to emphasize that all data sources employed in this application are obtained through legitimate channels, guaranteeing that all data processing complies with the requirements of relevant laws and regulations, and that user privacy and data security are protected.

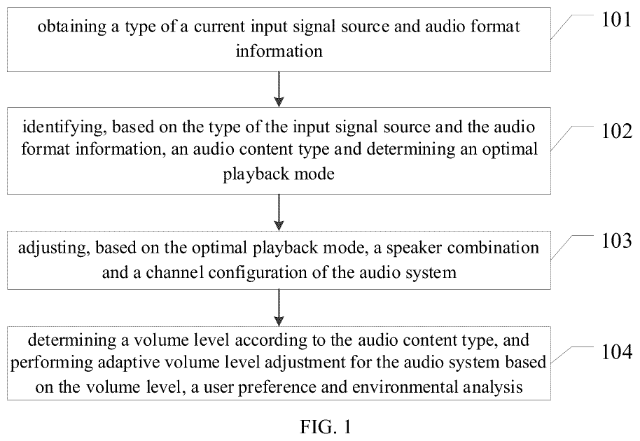

To facilitate technical comprehension, the specific process of the embodiments of the present disclosure is described below. As shown in FIG. 1, the audio system parameter configuration method according to the embodiments of this application includes the following steps.

101, obtaining a type of a current input signal source and audio format information.

A detection circuit of an audio input interface may be used. Different interfaces, such as High-Definition Multimedia Interface (HDMI), optical fiber, and Auxiliary (AUX), have unique electrical characteristics and protocol standards. The detection circuit can identify the type of the signal source based on these characteristics. For the HDMI interface, the Extended Display Identification Data (EDID) may be read, which includes detailed parameters such as the audio formats and resolutions supported by a signal source device. Furthermore, a driver and a signal processing algorithm may be employed. When a signal is inputted, the driver performs a preliminary parsing of the input signal to extract identifier information and determine the type of the signal source. Next, the signal processing algorithm performs deep analysis on the audio data. By identifying an encoding identifier, sampling rate, bit depth, and other information in a frame header of the audio data, the audio format is determined. In addition, the API interfaces provided by the operating system are utilized, and identifying information of the audio system is obtained, which corroborates the hardware detection and software analysis results, thereby accurately and comprehensively acquiring the type of the current input signal source and audio format information.

102, identifying, based on the type of the input signal source and the audio format information, an audio content type and determining an optimal playback mode.

The type of the signal source includes interfaces such as HDMI, optical fiber, or AUX, while the audio format information covers key parameters such as sampling rate, bit depth, and encoding format. For example, when the input signal comes from an HDMI interface and the audio format is multi-channel Linear Pulse-Code Modulation (LPCM) or Dolby Atmos, the type of the audio content may be determined to be a high-definition movie or game. When the signal source is an AUX interface and the audio format is stereo at 44.1 kHz and 16 bits, the type of the audio content may belong to a music or podcast category. Furthermore, according to the preset matching rule library, the optimal playback mode is precisely matched to different types of audio content. For example, for the high-definition movie or game, a playback mode with immersive surrounding sound effects is enabled, fully utilizing the advantages of multi-channel to enhance the spatial sense and three-dimensionality of the sound, making the audience or players feel as if they are in the scene. For music or podcasts, a playback mode focusing on sound quality restoration and detail presentation is adopted, optimizing the audio frequency response curve, improving the clarity and purity of the sound, and ensuring that every note and every word is clearly distinguishable, thereby providing users with the highest quality audio playback experience.

103, adjusting, based on the optimal playback mode, a speaker combination and a channel configuration of the audio system.

The specific requirements of the optimal playback mode for the speaker combination and channel configuration are analyzed.

For example, for the playback mode with immersive surround sound, the location and angle of each speaker in the audio system are calculated based on the spatial acoustic principle and speaker performance parameters. For the playback mode focused on sound quality restoration and detail presentation, the location and angle of each speaker in the audio system are calculated based on the spectral characteristics of the audio signal, the frequency response curve of the speaker, and the uniformity requirements of the sound field.

For the playback mode with immersive surround sound, a sound wave propagation simulation algorithm is used to analyze phenomena such as reflection and diffraction of the sound within the space. Combined with such performance parameters as the frequency response curve and directivity characteristics of the speaker, a genetic algorithm or a particle swarm optimization algorithm is used to iteratively calculate the optimal location and angle of each speaker with the objectives of creating a uniform sound field and reducing acoustic coloration.

For the playback mode focused on sound quality restoration and detail presentation, audio analysis software is used to analyze the spectral characteristics of the audio signal and clarify the energy distribution across different frequency bands. Combined with the frequency response curve of each speaker, mathematical modeling is applied to determine the optimal frequency band for each speaker to handle. A three-dimensional model of the listening room is constructed, and based on the requirements for sound field uniformity, a particle swarm optimization algorithm is employed. With the objective of minimizing the sound pressure level differences across frequency bands, the locations and angles of the speakers are iteratively calculated. For example, high-frequency speakers are placed near ear height to reduce reflections, low-frequency speakers are placed in corners to optimize standing waves, and mid-frequency speakers are directed toward a listening position to ensure clarity, thereby achieving precise sound quality restoration.

For example, in a living room environment, front left and right speakers are each placed at an appropriate distance on either side of a screen, a center speaker is arranged at the center of the screen, and rear surround speakers are installed on two sides or corners at the back according to the room size and shape, to create a realistic surround sound field.

For example, in a moderate-sized professional listening room, to accurately reproduce high-frequency details in the audio signal, speakers with excellent high-frequency response are placed in locations close to the listening position and at an appropriate height to reduce reflection and attenuation of the high-frequency signal. For the mid-frequency range, speakers with flat frequency response and low distortion are selected and arranged directly in front of the listening region to ensure clear reproduction of vocal and instrumental fundamental frequencies. Low-frequency speakers, based on the room's low-frequency standing wave conditions, are placed in corners or acoustically treated locations, and by adjusting their locations and angles, the low-frequency energy is evenly distributed throughout the listening space, avoiding low-frequency boom or localized excessive intensity, thereby achieving high-fidelity reproduction of full-frequency range sound quality.

In terms of channel configuration, audio signals are assigned and processed in real time through a digital signal processor. Specifically, for a multi-channel audio source, the digital signal processor accurately assigns the sound signals of different channels to the corresponding speakers, while adjusting such parameters as gain, delay, and phase of each channel to ensure that the sound is synchronized and harmonized in the acoustic space. In addition, it may monitor the operating status of the speakers, such as temperature and power, in real time, and dynamically adjust the speaker combination and channel configuration based on actual conditions, to ensure that the audio system always operates in an optimal state, providing users with a superior audio experience.

104, determining a volume level according to the audio content type, and performing adaptive volume level adjustment for the audio system based on the volume level, a user preference and environmental analysis.

A mapping database between audio content types and initial volume levels is pre-established. For different types of audio, such as movies, music, news, etc., reasonable initial volume ranges are set based on their dynamic range and acoustic characteristics. After identifying the type of currently playing audio content, the corresponding initial volume level is extracted from the database.

User volume preference information is collected, which includes the user's habitual volume settings during different time periods and in different scenarios, as well as personalized operation records of the user's volume adjustments. Environmental noise data is collected in real time, and such characteristics as noise intensity and frequency distribution are analyzed using a digital signal processing algorithm, to calculate the equivalent sound level of the environmental noise.

The final volume parameter is determined based on the user volume preference information, the equivalent sound level of environmental noise, and the initial volume level. Specifically, different weighting coefficients are assigned to the initial volume level, user volume preference information, and the equivalent sound level of environmental noise. These weighting coefficients may be dynamically adjusted according to the practical application scenario and user feedback. For the initial volume level, its weight primarily reflects the acoustic characteristics baseline of different types of audio content. For example, movie audio, due to its wide dynamic range, has a relatively large weight for the initial volume level, to ensure basic sound expressiveness. The weight of the user volume preference information reflects personalized user needs. When a user frequently adjusts the volume during specific time periods or in specific scenarios, the weight of the corresponding preference information may increase accordingly. The weight of the equivalent sound level of environmental noise is used to balance external noise interference. When environmental noise is high, this weight may be increased to ensure that the audio remains clearly audible in noisy environments. Next, a weighted sum of the initial volume level, the quantized user volume preference value (such as mapping preference volumes from different time periods to a specific numerical range), and the equivalent sound level of environmental noise is calculated to obtain a preliminary volume adjustment value. Next, a fuzzy logic control mechanism is introduced to fine-tune the preliminary adjustment value, considering the smoothness and comfort of volume changes to avoid discomfort caused by sudden volume shifts. For example, when the preliminary calculated volume change magnitude is too large, the fuzzy logic appropriately reduces the change amount to achieve gradual volume adjustment. Finally, after multi-weight fusion and fuzzy logic fine-tuning, the final volume parameter that best meets user needs and environmental conditions is determined, achieving adaptive adjustment of the audio system's volume.

For example, the scenario of using an audio system to watch a movie in the living room at home in the evening is taken as an example. When the initial volume level is 50, the current equivalent sound level of environmental noise in the living room is 30, and based on user volume preference information, it is determined that the user typically sets the volume between 40 and 45 when watching movies from 8:00 PM to 10:00 PM, with multiple previous manual adjustments to 42 during this time period. Considering the characteristics and importance of movie audio, the weight for the initial volume level is set to 0.4. Since the user has a clear volume preference during this time period, the weight for user volume preference information is set to 0.4; and as environmental noise may affect the viewing experience, the weight for the equivalent sound level of environmental noise is set to 0.2. The user volume preference information is quantified by taking a midpoint of the user's habitual volume range, 42.5, as a representative value. According to a weighted summation formula: preliminary volume adjustment value=initial volume level×weight of initial volume level+user volume preference value×weight of user volume preference information+equivalent sound level of environmental noise× weight of equivalent sound level of environmental noise=50×0.4+42.5×0.4+30×0.2=20+17+6=43. Considering the smoothness of volume changes, when the preliminary calculated volume change magnitude compared to the current volume (assuming the current volume is 40) is 3, which is within an acceptable range, but to further enhance the user experience, the fuzzy logic control mechanism decides to fine-tune the volume to 42. After multi-weight fusion and fuzzy logic fine-tuning, the final volume parameter is determined to be 42. The audio system plays the movie at this volume, which not only considers the characteristics of the movie audio but also meets the user's personalized needs while adapting to ambient noise conditions, providing the user with a comfortable viewing experience.

In the embodiments of this application, the type and format information of the signal source are obtained, the audio content type is identified based on the type and format information of the signal source, so as to determine the optimal playback mode. The speaker combination and channel configuration are adjusted based on the optimal playback mode, and a volume level is determined according to the audio content type, and adaptive volume level adjustment is performed for the audio system based on the volume level, a user preference and environmental analysis. This application fully considers multiple factors, adapts to different audio contents and diversified scenarios, improves the accuracy of audio system parameter configuration, and achieves personalized volume settings. It provides users with high-quality and comfortable audio experiences in various scenarios, significantly enhancing the effectiveness of the audio device and user satisfaction.

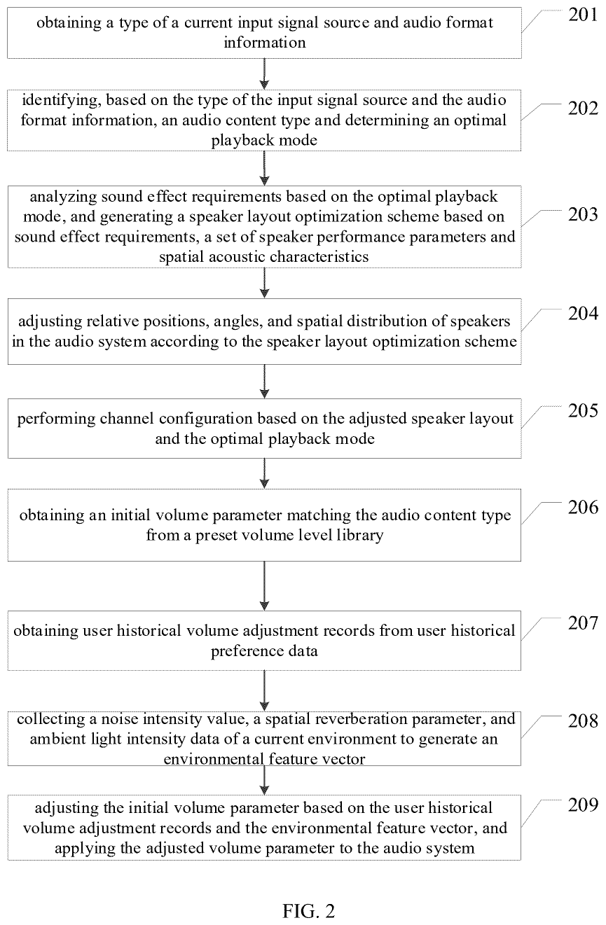

Please refer to FIG. 2, the audio system parameter configuration method according to some embodiments of this application includes the following steps.

201, obtaining a type of a current input signal source and audio format information.

The type of the current input signal source is detected through an audio system interface, where the type of the input signal source includes at least one of Bluetooth, Wi-Fi, or wired interface. Next, an audio format of the input signal source is parsed; where the audio format includes at least one of MP3, Waveform Audio File Format (WAV), Free Lossless Audio Codec (FLAC), and Advanced Audio Coding (AAC). A sampling rate and bit depth of the input signal source are identified to obtain the audio format information.

202, identifying, based on the type of the input signal source and the audio format information, an audio content type and determining an optimal playback mode.

A corresponding audio content type is queried based on the type of the input signal source and the audio format information in a database. A matching score for each playback mode corresponding to the current audio content type is calculated according to hardware performance of the audio system, a current environmental condition, and a user historical preference. A playback mode with the highest matching score is selected as the optimal playback mode.

A database including the correspondence among types of the signal source, audio format information, and audio content types is pre-established. A data retrieval algorithm is used to quickly query the corresponding audio content type based on the obtained signal source type and audio format information. For example, when the system is connected by a user via a Bluetooth interface and required to play a song in MP3 format, the data retrieval algorithm can swiftly query the database based on the signal source type (Bluetooth) and audio format information (MP3) to determine that the corresponding audio content type is “Music.”

Hardware performance parameters of the audio system, such as the frequency response range, power, distortion level of each speaker, and the processing capability of the processor, are collected. Current environmental condition data is collected through environmental sensors, including room dimensions, reverberation time, and background noise intensity. A user historical preference is extracted from user history records, such as the frequency of playback mode selections for different types of audio and volume adjustment habit. A multi-factor weighted scoring model is used to assign reasonable weighting coefficients to hardware performance, environmental condition, and user historical preference. A matching degree between each playback mode and the current audio content type is quantified based on these factors, and a matching score is calculated for each playback mode. For example, for an immersive playback mode, when the audio system hardware supports multi-channel output, the room reverberation time is moderate, and the user has a historical preference for this mode, then this mode has a higher score. By comparing matching scores of all playback modes, the playback mode with the highest score is selected as the optimal playback mode.

203, analyzing sound effect requirements based on the optimal playback mode, and generating a speaker layout optimization scheme based on the sound effect requirements, a set of speaker performance parameters and spatial acoustic characteristics.

The sound-effect feature parameters in the optimal playback mode are analyzed, and sound effect requirement indicators are determined based on the sound effect feature parameters. A matching degree between each sound-effect requirement indicator and the set of speaker performance parameters is evaluated, and the speaker in the audio system is screened based on a matching degree evaluation result to obtain a speaker screening result. Room acoustic feature parameters are obtained, where the room acoustic feature parameters include: room dimensions, a shape of a room, reverberation time, a reflection path, a sound absorption coefficient, and sound field distribution. A speaker layout optimization scheme is generated based on the speaker screening result and the room acoustic feature parameters.

Such sound-effect feature parameters as a frequency response range, a dynamic range, a sound field width, and a surround sound effect intensity are extracted from the optimal playback mode, and such multi-dimensional sound-effect requirement indicators of low-frequency impact, mid-frequency clarity, high-frequency delicacy, and sound field uniformity are determined based on these parameters. Detailed performance parameters of each speaker in the audio system are collected, to obtain a set of speaker performance parameters; where the detailed performance parameters include a frequency response curve, power output capability, a distortion level, and a directivity characteristic. The detailed performance parameters of each speaker are compared with the sound effect requirement indicators one by one, quantitative calculation is performed and a matching degree therebetween is evaluated by using a similarity calculation model and a matching degree evaluation algorithm. A reasonable matching threshold is set, and a speaker with a matching degree lower than the matching threshold is excluded to obtain a speaker screening result that meets the sound effect requirements. Room acoustic feature parameters are obtained by using an advanced acoustic measurement device and professional acoustic analysis software. To be specific, a plurality of measurement points is set in a room, such devices as a sound level meter and a microphone array are used to collect sound signals, and such parameters as room dimensions, a shape of a room, reverberation time, a reflection path, a sound absorption coefficient, and sound field distribution are analyzed and obtained. For the reverberation time, the impulse response measurement algorithm is used to accurately calculate the decay process of sound in the room. The reflection path is determined by simulating the propagation trajectory of sound in the room using a sound localization algorithm. The sound absorption coefficient is obtained by measuring the sound absorption performance of different materials using a standing wave tube algorithm or a reverberation chamber algorithm. A speaker layout optimization scheme is generated by using a multi-objective optimization algorithm based on the speaker screening result and the room acoustic feature parameters. To be specific, the highest sound field uniformity, the most accurate sound positioning, and the minimal low-frequency standing wave interference are set as objective functions, while considering such constraints as speaker physical dimensions, installation location limitations, and wiring rationality. A genetic algorithm or a particle swarm optimization algorithm is used to perform iterative searches in a multi-dimensional solution space, continuously adjust locations, angles, and spatial distribution of the speakers to determine an optimal speaker layout combination, and obtain the speaker layout optimization scheme.

Evaluating the matching degree between the sound-effect requirement indicator and the set of speaker performance parameters, and screening the speaker in the audio system based on the matching degree evaluation result to obtain the speaker screening result specifically includes: collecting a frequency response range, power output capability, and a distortion level of each speaker in the audio system, to obtain the set of speaker performance parameters, where the set of speaker performance parameters includes performance parameters of each speaker; calculating a similarity between each performance parameter of the speaker and the sound-effect indicator to obtain the corresponding matching degree; and excluding a speaker with a matching degree lower than a preset threshold to obtain the speaker screening result.

Test signals of different frequencies are transmitted, a frequency response range of each speaker is measured, an output amplitude and phase response at different frequencies are recorded. A power meter is used to measure the power output capability of the speaker under different input signals, obtaining such parameters as maximum power and rated power. A distortion meter is used to test the distortion level of the speaker at different volumes and frequencies, obtaining such specific values as harmonic distortion and intermodulation distortion. These data are integrated to form a set of speaker performance parameters including detailed information such as the frequency response range, power output capability, and distortion level of each speaker. For each speaker, a cosine similarity algorithm is used to calculate similarities between its performance parameters and the audio-effect indicators. The frequency response range of the speaker is compared with a frequency distribution requirement in the audio-effect requirements, and a similarity between the two in the frequency domain is calculated. For power output capability, based on a dynamic range requirement in the audio-effect requirements, whether the speaker's power meets the corresponding requirement is evaluated and a similarity is calculated. For distortion level, based on a sound purity requirement in the audio-effect requirements, a similarity between the speaker's distortion level and an expected value is calculated. A comprehensive weighted calculation is performed on the similarities from these three dimensions to obtain a matching degree between each speaker and the audio-effect indicators. A reasonable preset threshold is set, which may be adjusted according to the overall performance requirements of the audio system and the importance of the audio-effect requirements. A speaker with a matching degree lower than the preset threshold is determined to be unable to meet the audio-effect requirements and are excluded from a speaker list, thereby obtaining a speaker screening result that meets the audio-effect requirements.

Generating the speaker layout optimization scheme based on the speaker screening result and the room acoustic feature parameters specifically includes: setting objective functions for speaker layout optimization based on the speaker screening result and the room acoustic feature parameters; setting constraints based on physical dimensions and installation position of each speaker; performing iterative calculations by using a genetic algorithm under the set objective functions and constraints, determining the optimal locations, angles, and spatial distribution of the speakers, and outputting the speaker layout optimization scheme.

Based on the speaker screening result, it determines a set of speakers to participate in the layout optimization. In combination with room acoustic feature parameters, such as room dimensions, a shape of the room, reverberation time, reflection paths, sound absorption coefficients, and sound field distribution, to establish objective functions for speaker layout optimization through comprehensively considering sound field uniformity, sound clarity, and surround sound effect. The sound field uniformity is measured by calculating sound pressure level differences at various locations in the room. The sound clarity is evaluated based on a ratio of direct sound to reflected sound; and the surround sound effect is determined according to a phase difference and time difference between speakers. These indicators are quantified and weighted summed to establish the objective functions that comprehensively reflects the quality of the speaker layout.

The constraint conditions are set based on the physical dimensions and installation location of each speaker. Specifically, a length, width, and height of the speaker is measured to define its spatial occupancy. Combining this with the room layout, considering wall load-bearing capacity and cable routing paths, it determines a feasible installation region. In accordance with acoustic requirements, minimum spacing between speakers is established to prevent acoustic interference and ensure optimal sound performance.

When performing iterative calculations by using a genetic algorithm under the set objective functions and constraints to output the speaker layout optimization scheme, it first initializes a set of random speaker locations, angles, and spatial distributions as population individuals. Next, such objectives as sound field uniformity and sound clarity are quantified, weights are set to establish a fitness function, and feasible solutions are filtered based on such constraint conditions as the physical dimensions of the speakers, installation locations, and the minimum spacing. A new population is generated through selection, crossover, and mutation operations. Next, it iterates generation by generation, retains high-fitness individuals, and eliminates low-fitness individuals until the termination conditions are met. Finally, the optimization scheme including the optimal combination of speaker locations, angles, and spatial distribution is outputted.

204, adjusting relative positions, angles, and spatial distribution of speakers in the audio system according to the speaker layout optimization scheme.

An electric adjustment mechanism in the audio system is controlled to adjust the relative positions and angles of the speakers according to the speaker layout optimization scheme. Whether the angle of each speaker is correctly adjusted is determined by using an angle sensor, and whether the adjusted spatial distribution of the speakers meets the requirements of the speaker layout optimization scheme is verified.

By means of the electric adjustment mechanism equipped in the audio system, the speakers are driven to move to the designated locations and adjusted to the corresponding angles through preset control instructions. During the adjustment process, an angle sensor is used to monitor angle changes of each speaker in real time, and data fed back by the sensor is compared with a set value of the speaker layout optimization scheme to determine whether the angle is adjusted accurately. After the adjustment is completed, three-dimensional spatial measurement technology and acoustic simulation software are used to fully verify whether the adjusted spatial distribution of the speakers strictly meets the requirements of the optimal speaker layout scheme.

205, performing channel configuration based on the adjusted speaker layout and the optimal playback mode.

A correspondence between each sound element and an available audio channel is determined based on an acoustic requirement of the optimal playback mode, and an audio signal of each channel is assigned to the corresponding speaker based on the adjusted speaker layout.

The acoustic characteristics of the optimal playback mode are analyzed, the positioning and performance requirements of different sound elements, such as dialogue, background music, ambient sound effects, in the sound field are clarified, to determine the correspondence between each sound element and the available audio channel. In combination with the adjusted speaker layout, taking into account the locations, angles and performance characteristics of the speakers, the sound signals of channels are assigned to the corresponding speakers by using an audio processing algorithm and a mapping rule, so as to ensure that each speaker can accurately reproduce the sound element it is in charge of.

206, obtaining an initial volume parameter matching the audio content type from a preset volume level library.

The audio content type is identified and its category is determined, such as music, movies, news, etc. The preset volume level library includes initial volume parameter ranges for different audio types that have been professionally calibrated. Based on an identifying result, a matching initial volume parameter is quickly retrieved and extracted from the volume level library.

207, obtaining user historical volume adjustment records from user historical preference data.

A database specifically designed for storing user preference data is accessed. This database records volume adjustment operations performed by users for different audio content types during their past use of the audio system, including such information as time of adjustment, a magnitude of adjustment, and the audio content type. Through a specific query algorithm, it accurately filters out a historical volume adjustment record related to the target audio from the massive data.

208, collecting a noise intensity value, a spatial reverberation parameter, and ambient light intensity data of a current environment to generate an environmental feature vector.

The noise intensity value, the spatial reverberation parameter, and ambient light intensity data of the current environment are collected using the environmental sensor. Next, the noise intensity value, the spatial reverberation parameter, and ambient light intensity data of the current environment are inputted into a predefined environmental analysis model to obtain the environmental feature vector; where the environmental analysis model is a multimodal data fusion-based machine learning model that, through jointly learning a nonlinear mapping relationship among the noise intensity, spatial reverberation, and light intensity, outputs a normalized environmental feature vector.

209, adjusting the initial volume parameter based on the user historical volume adjustment records and the environmental feature vector, and applying the adjusted volume parameter to the audio system.

An average volume adjustment offset of the user for a same category of audio content type and in a similar environment is calculated by using the user historical volume adjustment records. The environmental feature vector is inputted into a preset volume compensation regression model, and a corresponding environmental volume compensation coefficient is outputted by analyzing a synergistic influence relationship of noise intensity, spatial reverberation, and light intensity. Next, the adjusted volume parameter is determined based on the average volume adjustment offset, the environmental volume compensation coefficient, and the initial volume parameter.

The audio content types in the user historical volume adjustment records are categorized by using text recognition and feature extraction technologies. Furthermore, in combination with the sensor data and a pattern recognition algorithm, an environmental similarity index is quantified based on such factors as temperature, humidity, and spatial layout. Next, it filters the adjustment records that belong to the same audio content category and fall within the similarity threshold, extracts the offset data of each adjustment, and by using an arithmetic mean algorithm, sums all valid offsets and divides by the quantity of records to obtain the average volume adjustment offset. This reflects the user's general volume preference trend for that category of audio content and under similar environmental conditions.

The volume compensation regression model adopts a deep learning architecture, and is pre-trained using a large amount of labeled data including environmental features and corresponding volume compensation coefficients. During the model training process, the network parameters are continuously optimized through a backpropagation algorithm to accurately learn the synergistic influence relationship among noise intensity, spatial reverberation, and light intensity. In practical applications, the collected environmental feature vector is inputted into the trained model. The model calculates and outputs the corresponding environmental volume compensation coefficient through forward propagation.

A first weight ω1 is set to the average volume adjustment offset and a second weight ω2 is set to the environmental volume compensation coefficient, where ω1+ω2=1; a comprehensive adjustment coefficient k is calculated based on the initial volume parameter, the average volume adjustment offset, the environmental volume compensation coefficient, the first weight, and the second weight; and the adjusted volume parameter is calculated according to the comprehensive adjustment coefficient and the initial volume parameter.

A formula of calculating the comprehensive adjustment coefficient k is:

$$k = 1 + ω 1 \times \frac{average volume adjustment offset}{initial volume parameter} + ω2 \times ( environmental volume compensation coefficient - 1 )$$

$$adjusted volume parameter = initial volume parameter \times k$$

For example, the initial volume parameter is set to 50, the average volume adjustment offset is 7.2, the environmental volume compensation coefficient is 0.8, @1=0.5, and @2=0.5, k=1+0.5×7.2/50+0.5×(0.8−1)=0.972, and the adjusted volume parameter=50×0.972≈49. When the initial volume parameter is set to 50, the average volume adjustment offset is 7.2, the environmental volume compensation coefficient is 0.8, ω1=0.7, and ω2=0.3, k=1+0.7×7.2/50+0.3×(0.8−1)=1.0408, and the adjusted volume parameter=50×1.0408≈52.

In the embodiments of this application, the type of the current input signal source and audio format information are obtained, the audio content type is identified based on the type of the input signal source and the audio format information and the optimal playback mode is determined. Sound effect requirements are analyzed based on the optimal playback mode, and the speaker layout optimization scheme is generated based on the sound effect requirements, the set of speaker performance parameters and spatial acoustic characteristics. Next, relative positions, angles, and spatial distribution of speakers in the audio system are adjusted according to the speaker layout optimization scheme, and channel configuration is performed based on the adjusted speaker layout and the optimal playback mode. The initial volume parameter matching the audio content type is obtained from the preset volume level library, and user historical volume adjustment records are obtained from user historical preference data. The noise intensity value, the spatial reverberation parameter, and ambient light intensity data of the current environment are collected to generate the environmental feature vector. The initial volume parameter is adjusted based on the user historical volume adjustment records and the environmental feature vector, so as to achieve personalized adaptive volume adjustment, and perform parameter configuration through comprehensively considering multiple factors, thereby adapting to different audio contents and diversified scenarios, greatly improving the configuration accuracy of the audio system, and providing users with a higher quality, more comfortable, and needs-fitting audio experience in different scenarios.

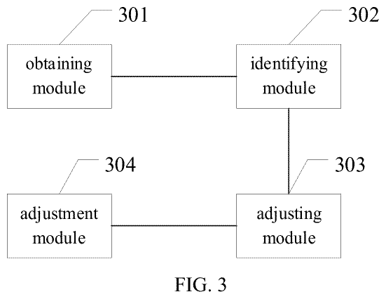

The above describes the audio system parameter configuration method in the embodiments of this application. Next, the audio system parameter configuration apparatus in the embodiments of this application will be described below. Please refer to FIG. 3, the audio system parameter configuration apparatus according to some embodiments of this application includes: an obtaining module 301, configured to obtain a type of a current input signal source and audio format information; an identifying module 302, configured to identify, based on the type of the input signal source and the audio format information, an audio content type and determining an optimal playback mode; an adjusting module 303, configured to adjust, based on the optimal playback mode, a speaker combination and a channel configuration of the audio system; and an adjustment module 304, configured to determine a volume level according to the audio content type, and perform adaptive volume level adjustment for the audio system based on the volume level, a user preference and environmental analysis.

In the embodiments of this application, the type and format information of the signal source are obtained, the audio content type is identified based on the type and format information of the signal source, so as to determine the optimal playback mode. The speaker combination and channel configuration are adjusted based on the optimal playback mode, and a volume level is determined according to the audio content type, and adaptive volume level adjustment is performed for the audio system based on the volume level, a user preference and environmental analysis. This application fully considers multiple factors, adapts to different audio contents and diversified scenarios, improves the accuracy of audio system parameter configuration, and achieves personalized volume settings. It provides users with high-quality and comfortable audio experiences in various scenarios, significantly enhancing the effectiveness of the audio device and user satisfaction.

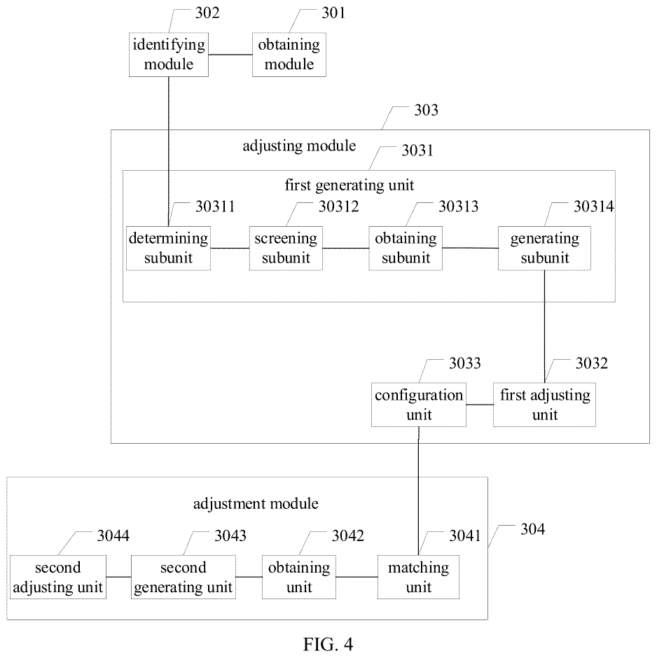

Please refer to FIG. 4, the audio system parameter configuration apparatus according to some embodiments of this application includes: an obtaining module 301, configured to obtain a type of a current input signal source and audio format information; an identifying module 302, configured to identify, based on the type of the input signal source and the audio format information, an audio content type and determining an optimal playback mode; an adjusting module 303, configured to adjust, based on the optimal playback mode, a speaker combination and a channel configuration of the audio system; and an adjustment module 304, configured to determine a volume level according to the audio content type, and perform adaptive volume level adjustment for the audio system based on the volume level, a user preference and environmental analysis.

Optionally, the obtaining module 301 may be specifically configured to: detect the type of the current input signal source through an audio system interface, where the type of the input signal source includes at least one of Bluetooth, Wi-Fi, or wired interface; parse an audio format of the input signal source; wherein the audio format includes at least one of MP3, Waveform Audio File Format (WAV), Free Lossless Audio Codec (FLAC), and Advanced Audio Coding (AAC); and identify a sampling rate and bit depth of the input signal source to obtain the audio format information.

Optionally, the identifying module 302 may be specifically configured to: query, based on the type of the input signal source and the audio format information, a corresponding audio content type in a database; calculate, according to hardware performance of the audio system, a current environmental condition, and a user historical preference, a matching score for each playback mode corresponding to the current audio content type; and select a playback mode with the highest matching score as the optimal playback mode.

Optionally, the adjusting module 303 includes: a first generating unit 3031, configured to analyze sound effect requirements based on the optimal playback mode, and generate a speaker layout optimization scheme based on the sound effect requirements, a set of speaker performance parameters and spatial acoustic characteristics; a first adjusting unit 3032, configured to adjust relative positions, angles, and spatial distribution of speakers in the audio system according to the speaker layout optimization scheme; and a configuration unit 3033, configured to perform channel configuration based on the adjusted speaker layout and the optimal playback mode.

Optionally, the first generating unit 3031 includes: a determining subunit 30311, configured to analyze sound-effect feature parameters in the optimal playback mode, and determine sound effect requirement indicators based on the sound effect feature parameters; a screening subunit 30312, configured to evaluate a matching degree between each sound-effect requirement indicator and the set of speaker performance parameters, and screen the speaker in the audio system based on a matching degree evaluation result to obtain a speaker screening result; an obtaining subunit 30313, configured to obtain room acoustic feature parameters, where the room acoustic feature parameters includes: room dimensions, a shape of a room, reverberation time, a reflection path, a sound absorption coefficient, and sound field distribution; and a generating subunit 30314, configured to generate a speaker layout optimization scheme based on the speaker screening result and the room acoustic feature parameters.

Optionally, the screening subunit 30312 may be specifically configured to: collect a frequency response range, power output capability, and a distortion level of each speaker in the audio system, to obtain the set of speaker performance parameters, where the set of speaker performance parameters includes performance parameters of each speaker; calculate a similarity between each performance parameter of the speaker and the sound-effect indicator to obtain the corresponding matching degree; and exclude a speaker with a matching degree lower than a preset threshold to obtain the speaker screening result.

Optionally, the generating subunit 30314 may be specifically configured to: set objective functions for speaker layout optimization based on the speaker screening result and the room acoustic feature parameters; set constraints based on physical dimensions and installation location of each speaker; perform iterative calculations by using a genetic algorithm under the set objective functions and constraints, determine the optimal locations, angles, and spatial distribution of the speakers, and output the speaker layout optimization scheme.

Optionally, the configuration unit 3033 may be specifically configured to: determine, based on an acoustic requirement of the optimal playback mode, a correspondence between each sound element and an available audio channel; and assign, based on the adjusted speaker layout, an audio signal of each channel to the corresponding speaker.

Optionally, the adjustment module 304 includes: a matching unit 3041, configured to obtain an initial volume parameter matching the audio content type from a preset volume level library; an obtaining unit 3042, configured to obtain user historical volume adjustment records from user historical preference data; a second generating unit 3043, configured to collect a noise intensity value, a spatial reverberation parameter, and ambient light intensity data of a current environment to generate an environmental feature vector; and a second adjusting unit 3044, configured to adjust the initial volume parameter based on the user historical volume adjustment records and the environmental feature vector, and apply the adjusted volume parameter to the audio system.

Optionally, the second generating unit 3043 may be specifically configured to: collect, using the environmental sensor, the noise intensity value, the spatial reverberation parameter, and ambient light intensity data of the current environment; input the noise intensity value, the spatial reverberation parameter, and ambient light intensity data of the current environment into a predefined environmental analysis model to obtain the environmental feature vector; where the environmental analysis model is a multimodal data fusion-based machine learning model that, through jointly learning a nonlinear mapping relationship among the noise intensity, spatial reverberation, and light intensity, outputs a normalized environmental feature vector.

Optionally, the second adjusting unit 3044 may be specifically configured to: calculate an average volume adjustment offset of the user for a same category of audio content type and in a similar environment by using the user historical volume adjustment records; input the environmental feature vector into a preset volume compensation regression model, and output a corresponding environmental volume compensation coefficient by analyzing a synergistic influence relationship of noise intensity, spatial reverberation, and light intensity; and determine the adjusted volume parameter based on the average volume adjustment offset, the environmental volume compensation coefficient, and the initial volume parameter.

In the embodiments of this application, the type of the current input signal source and audio format information are obtained, the audio content type is identified based on the type of the input signal source and the audio format information and the optimal playback mode is determined. Sound effect requirements are analyzed based on the optimal playback mode, and the speaker layout optimization scheme is generated based on the sound effect requirements, the set of speaker performance parameters and spatial acoustic characteristics. Next, relative positions, angles, and spatial distribution of speakers in the audio system are adjusted according to the speaker layout optimization scheme, and channel configuration is performed based on the adjusted speaker layout and the optimal playback mode. The initial volume parameter matching the audio content type is obtained from the preset volume level library, and user historical volume adjustment records are obtained from user historical preference data. The noise intensity value, the spatial reverberation parameter, and ambient light intensity data of the current environment are collected to generate the environmental feature vector. The initial volume parameter is adjusted based on the user historical volume adjustment records and the environmental feature vector, so as to achieve personalized adaptive volume adjustment, and perform parameter configuration through comprehensively considering multiple factors, thereby adapting to different audio contents and diversified scenarios, greatly improving the configuration accuracy of the audio system, and providing users with a higher quality, more comfortable, and needs-fitting audio experience in different scenarios.

In FIG. 3 and FIG. 4, the audio system parameter configuration method in the embodiments of this application is described in detail in the form of modular functional entities. An electronic device in the embodiments of this application will be described hereinafter in the form of hardware processing.

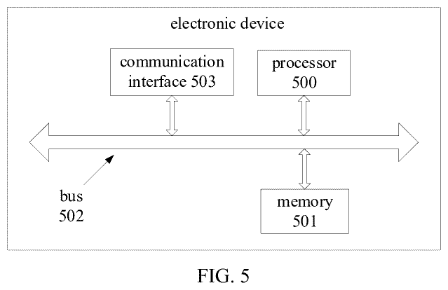

As shown in FIG. 5, the electronic device includes a processor 500 and a memory 501. The memory 501 stores machine executable instructions that can be executed by the processor 500, the machine executable instructions, when executed by the processor 500, cause the processor 500 to implement the above audio system parameter configuration method.

Furthermore, the electronic device in FIG. 5 further includes a bus 502 and a communication interface 503, and the processor 500, the communication interface 503 and the memory 501 are connected via the bus 502.

The memory 501 may include a high-speed random access memory (RAM), or a non-volatile memory (non-volatile memory), for example, at least one disk storage. The communication connection between the system network element and at least one other network element is realized through at least one communication interface 503 (which may be wired or wireless), and the Internet, wide area network, local area network, metropolitan area network, etc. may be used. The bus 502 may be an Industry Standard Architecture (ISA) bus, a Peripheral Component Interconnect (PCI) bus, or an Extended Industry Standard Architecture (EISA) bus, etc. The bus may be categorized as an address bus, a data bus, a control bus, etc. For ease of representation, only one bidirectional arrow is used in FIG. 5, but it does not mean that there is only one bus or one type of bus.

The processor 500 may be an integrated circuit with signal processing capability. In the implementation process, the various steps of the above method may be implemented by an integrated logic circuit of the processor 500 in hardware form or implemented by instructions in the form of software in the processor 500. The processor 500 may be a general-purpose processor, including a central processing unit (CPU), a network processor (NP), etc. The processor 500 may also be a digital signal processor (DSP), an application specific integrated circuit (ASIC), a field programmable gate array (FPGA) or any other programmable logic device, discrete gate or transistor logic device, discrete hardware component. Various methods, steps and logic block diagrams in the embodiments of this application may be implemented or carried out. The general processor may be a micro-processor or any conventional processor, etc. The steps of the method in the embodiments of this application may be directly implemented by a hardware decoding processor, or implemented by a combination of hardware and software modules in the decoding processor. The software modules may be located in a storage medium well-known in the art, such as a random access memory, a flash memory, a read-only memory, a programmable read-only memory, or an electrically erasable programmable memory, a register. The storage medium is located in the memory 501, and the processor 500 reads the information in the memory 501 and finishes the method steps of the above-mentioned embodiment in combination with its hardware.

This application further provides an electronic device, where a computer device includes a memory and a processor. The memory has stored thereon computer-readable instructions, which, when executed by the processor, cause the processor to perform the steps of the audio system parameter configuration method in the above embodiments.

This application further provides a computer-readable storage medium, which may be a non-volatile computer-readable storage medium or a volatile computer-readable storage medium. The computer-readable storage medium may be a volatile computer-readable storage medium having stored thereon instructions, the instructions, when executed on a computer, cause the computer to implement the steps of the audio system parameter configuration method.

Those skilled in the art may clearly understand that, for the sake of convenience and brevity of description, the specific working process of the system, apparatus and units mentioned above can refer to the corresponding processes in the method embodiments, which are not elaborated again.

If the integrated unit is implemented in the form of software functional units and sold or used as an independent product, it may be stored in a computer readable storage medium. Based on this understanding, essence of the technical solutions of this application, or the part contributing to the prior art, or all or part of the technical solutions, may be embodied in the form of a software product. The computer software product is stored in a storage medium, and includes a number of instructions to enable a computer device (which may be a personal computer, a server, or a network device, etc.) to perform all or part of the steps of method described in the various embodiments of this application. The storage medium includes a USB flash disk, a mobile hard disk, a read-only memory (Read-Only Memory, ROM), a random access memory (Random Access Memory, RAM), a magnetic disk, an optical disk, or other medium which can store program code.

The above embodiments are merely used to illustrate the technical solutions of this application, but shall not be construed as limiting this application. As can be appreciated by a person skilled in the art, although this application has been described in detail with reference to the foregoing embodiments, any modifications or variations of the technical solutions in the aforementioned embodiments, or equivalent replacements of part of the technical features within the scope of the disclosed technology, may still be made by those skilled in the art. These modifications, variations or replacements do not make the essence of the corresponding technical solutions depart from the spirit and scope of the technical solutions of the embodiments of this application.

What is claimed is:

1. An audio system parameter configuration method, comprising:
obtaining a type of an input signal source and audio format information;
identifying, based on the type of the input signal source and the audio format information, an audio content type and determining an optimal playback mode;
adjusting, based on the optimal playback mode, a speaker combination and a channel configuration of an audio system; and
determining a volume level according to the audio content type, and performing adaptive volume level adjustment for an audio device based on the volume level, a user preference, and environmental analysis;
wherein the determining the volume level according to the audio content type, and performing the adaptive volume level adjustment for the audio device based on the volume level, the user preference, and the environmental analysis comprises:
obtaining an initial volume parameter matching the audio content type from a preset volume level library;
obtaining user historical volume adjustment records from user historical preference data;
collecting, using an environmental sensor, a noise intensity value, a spatial reverberation parameter, and ambient light intensity data of a current environment to generate an environmental feature vector;
calculating an average volume adjustment offset of a user for a same category of audio content type and in a similar environment by using the user historical volume adjustment records;
inputting the environmental feature vector into a preset volume compensation regression model, and outputting an environmental volume compensation coefficient by analyzing a synergistic influence relationship of noise intensity, spatial reverberation, and light intensity; and
determining an adjusted volume parameter based on the average volume adjustment offset, the environmental volume compensation coefficient, and the initial volume parameter, and applying the adjusted volume parameter to the audio system;
wherein a first weight ω1 is set to the average volume adjustment offset and a second weight ω2 is set to the environmental volume compensation coefficient, wherein ω1+ω2=1; a comprehensive adjustment coefficient k is calculated based on the initial volume parameter, the average volume adjustment offset, the environmental volume compensation coefficient, the first weight, and the second weight; and the adjusted volume parameter is calculated according to the comprehensive adjustment coefficient and the initial volume parameter;
wherein a formula of calculating the comprehensive adjustment coefficient k is:
$$k = 1 + ω 1 \times \frac{average volume adjustment offset}{initial volume parameter} + ω2 \times ( environmental volume compensation coefficient - 1 )$$
$$the adjusted volume parameter = the initial volume parameter \times k ;$$
wherein the adjusting, based on the optimal playback mode, the speaker combination and the channel configuration of the audio system comprises:
extracting a frequency response range, a dynamic range, a sound field width, and a surround sound effect intensity from the optimal playback mode to obtain sound-effect feature parameters;
determining, based on the sound-effect feature parameters, multi-dimensional sound-effect requirement indicators of low-frequency impact, mid-frequency clarity, high-frequency delicacy, and sound field uniformity;
collecting detailed performance parameters of each speaker in the audio system, to obtain a set of speaker performance parameters; wherein the detailed performance parameters comprise a frequency response curve, power output capability, a distortion level, and a directivity characteristic;
comparing the detailed performance parameters of each speaker with the multi-dimensional sound-effect requirement indicators one by one and performing quantitative calculation and evaluating a matching degree therebetween by using a similarity calculation model and a matching degree evaluation algorithm;
setting a reasonable matching threshold, and excluding a speaker with a matching degree lower than the reasonable matching threshold to obtain a speaker screening result, wherein the speaker screening result meets sound effect requirements;
obtaining room acoustic feature parameters by using an acoustic measurement device and an acoustic analysis software; wherein a plurality of measurement points is set in a room, a sound level meter and a microphone array device are configured to collect sound signals, and room dimensions, a shape of the room, reverberation time, a reflection path, a sound absorption coefficient, and sound field distribution are analyzed and obtained to obtain the room acoustic feature parameters; for the reverberation time, an impulse response measurement algorithm is configured to accurately calculate a decay process of sound in the room; the reflection path is determined by simulating a propagation trajectory of the sound in the room using a sound localization algorithm; and the sound absorption coefficient is obtained by measuring sound absorption performance of different materials using a standing wave tube algorithm or a reverberation chamber algorithm;
generating a speaker layout optimization scheme by using a multi-objective optimization algorithm based on the speaker screening result and the room acoustic feature parameters; wherein a highest sound field uniformity, a most accurate sound positioning, and a minimal low-frequency standing wave interference are set as objective functions, while considering constraints comprising speaker physical dimensions, installation location limitations, and wiring rationality; a genetic algorithm or a particle swarm optimization algorithm is configured to perform iterative searches in a multi-dimensional solution space, continuously adjust locations, angles, and spatial distribution of speakers to determine an optimal speaker layout combination, and obtain the speaker layout optimization scheme;
adjusting relative positions, the angles, and the spatial distribution of the speakers in the audio system according to the speaker layout optimization scheme; and
performing the channel configuration based on an adjusted speaker layout and the optimal playback mode.

2. The audio system parameter configuration method according to claim 1, wherein the obtaining the type of the input signal source and the audio format information comprises:
detecting the type of the input signal source through an audio system interface, wherein the type of the input signal source comprises at least one of Bluetooth, Wireless Fidelity (Wi-Fi), or wired interface;
parsing an audio format of the input signal source; wherein the audio format comprises at least one of MPEG-1 layer III (MP3), Waveform Audio File Format (WAV), Free Lossless Audio Codec (FLAC), and Advanced Audio Coding (AAC); and
identifying a sampling rate and a bit depth of the input signal source to obtain the audio format information.

3. The audio system parameter configuration method according to claim 1, wherein the identifying the audio content type and determining the optimal playback mode based on the type of the input signal source and the audio format information comprises:
querying, based on the type of the input signal source and the audio format information, a corresponding audio content type in a database;
calculating, according to hardware performance of the audio system, a current environmental condition, and a user historical preference, a matching score for each playback mode corresponding to the audio content type; and
selecting a playback mode with a highest matching score as the optimal playback mode.

4. The audio system parameter configuration method according to claim 1, wherein the adjusting the relative positions, the angles, and the spatial distribution of the speakers in the audio system according to the speaker layout optimization scheme comprises:
controlling an electric adjustment mechanism in the audio system to adjust the relative positions and the angles of the speakers according to the speaker layout optimization scheme;
determining whether the angle of each of the speakers is correctly adjusted by using an angle sensor; and
verifying whether adjusted spatial distribution of the speakers meets requirements of the speaker layout optimization scheme.

5. The audio system parameter configuration method according to claim 1, wherein the performing the channel configuration based on the adjusted speaker layout and the optimal playback mode comprises:
determining, based on an acoustic requirement of the optimal playback mode, a correspondence between each sound element and an available audio channel; and
assigning, based on the adjusted speaker layout, an audio signal of each channel to a corresponding speaker.

6. The audio system parameter configuration method according to claim 1, wherein the collecting the noise intensity value, the spatial reverberation parameter, and the ambient light intensity data of the current environment to generate the environmental feature vector comprises:
collecting, using the environmental sensor, the noise intensity value, the spatial reverberation parameter, and the ambient light intensity data of the current environment; and
inputting the noise intensity value, the spatial reverberation parameter, and the ambient light intensity data of the current environment into a predefined environmental analysis model to obtain the environmental feature vector; wherein the predefined environmental analysis model is a multimodal data fusion-based machine learning model, wherein the multimodal data fusion-based machine learning model outputs a normalized environmental feature vector through jointly learning a nonlinear mapping relationship among the noise intensity, the spatial reverberation, and the light intensity.

7. An audio system parameter configuration apparatus, comprising:
an obtaining module, configured to obtain a type of an input signal source and audio format information;
an identifying module, configured to identify, based on the type of the input signal source and the audio format information, an audio content type and determine an optimal playback mode;
an adjusting module, configured to adjust, based on the optimal playback mode, a speaker combination and a channel configuration of an audio system; and
an adjustment module, configured to determine a volume level according to the audio content type, and perform adaptive volume level adjustment for an audio device based on the volume level, a user preference, and environmental analysis;
wherein the determining the volume level according to the audio content type, and performing the adaptive volume level adjustment for the audio system based on the volume level, the user preference, and the environmental analysis comprises:
obtaining an initial volume parameter matching the audio content type from a preset volume level library;
obtaining user historical volume adjustment records from user historical preference data;
collecting, using an environmental sensor, a noise intensity value, a spatial reverberation parameter, and ambient light intensity data of a current environment to generate an environmental feature vector;
calculating an average volume adjustment offset of a user for a same category of audio content type and in a similar environment by using the user historical volume adjustment records;
inputting the environmental feature vector into a preset volume compensation regression model, and outputting an environmental volume compensation coefficient by analyzing a synergistic influence relationship of noise intensity, spatial reverberation, and light intensity; and
determining an adjusted volume parameter based on the average volume adjustment offset, the environmental volume compensation coefficient, and the initial volume parameter, and applying the adjusted volume parameter to the audio system;
wherein a first weight ω1 is set to the average volume adjustment offset and a second weight ω2 is set to the environmental volume compensation coefficient, wherein ω1+ω2=1; a comprehensive adjustment coefficient k is calculated based on the initial volume parameter, the average volume adjustment offset, the environmental volume compensation coefficient, the first weight, and the second weight; and the adjusted volume parameter is calculated according to the comprehensive adjustment coefficient and the initial volume parameter;
wherein a formula of calculating the comprehensive adjustment coefficient k is:
$$k = 1 + ω 1 \times \frac{average volume adjustment offset}{initial volume parameter} + ω2 \times ( environmental volume compensation coefficient - 1 )$$
$$the adjusted volume parameter = the initial volume parameter \times k ;$$
wherein the adjusting module is configured to:
extract a frequency response range, a dynamic range, a sound field width, and a surround sound effect intensity from the optimal playback mode to obtain sound-effect feature parameters;
determine, based on the sound-effect feature parameters, multi-dimensional sound-effect requirement indicators of low-frequency impact, mid-frequency clarity, high-frequency delicacy, and sound field uniformity;
collect detailed performance parameters of each speaker in the audio system, to obtain a set of speaker performance parameters; wherein the detailed performance parameters comprise a frequency response curve, power output capability, a distortion level, and a directivity characteristic;
compare the detailed performance parameters of each speaker with the multi-dimensional sound-effect requirement indicators one by one and perform quantitative calculation and evaluate a matching degree therebetween by using a similarity calculation model and a matching degree evaluation algorithm;
set a reasonable matching threshold, and excluding a speaker with a matching degree lower than the reasonable matching threshold to obtain a speaker screening result, wherein the speaker screening result meets sound effect requirements;
obtain room acoustic feature parameters by using an acoustic measurement device and an acoustic analysis software; wherein a plurality of measurement points is set in a room, a sound level meter and a microphone array device are configured to collect sound signals, and room dimensions, a shape of the room, reverberation time, a reflection path, a sound absorption coefficient, and sound field distribution are analyzed and obtained to obtain the room acoustic feature parameters; for the reverberation time, an impulse response measurement algorithm is configured to accurately calculate a decay process of sound in the room; the reflection path is determined by simulating a propagation trajectory of the sound in the room using a sound localization algorithm; and the sound absorption coefficient is obtained by measuring sound absorption performance of different materials using a standing wave tube algorithm or a reverberation chamber algorithm;
generate a speaker layout optimization scheme by using a multi-objective optimization algorithm based on the speaker screening result and the room acoustic feature parameters; wherein a highest sound field uniformity, a most accurate sound positioning, and a minimal low-frequency standing wave interference are set as objective functions, while considering constraints comprising speaker physical dimensions, installation location limitations, and wiring rationality; a genetic algorithm or a particle swarm optimization algorithm is configured to perform iterative searches in a multi-dimensional solution space, continuously adjust locations, angles, and spatial distribution of speakers to determine an optimal speaker layout combination, and obtain the speaker layout optimization scheme;
adjust relative positions, the angles, and the spatial distribution of the speakers in the audio system according to the speaker layout optimization scheme; and
perform the channel configuration based on an adjusted speaker layout and the optimal playback mode.

8. An electronic device, comprising:
a memory; and
at least one processor;
wherein the memory has stored thereon instructions, and the instructions, when executed by the at least one processor, cause the electronic device to perform the audio system parameter configuration method according to claim 1.

9. A computer readable storage medium, wherein instructions are stored on the computer readable storage medium, and the instructions are executed by a processor to perform the audio system parameter configuration method according to claim 1.

10. The electronic device according to claim 8, wherein in the audio system parameter configuration method, the obtaining the type of the input signal source and the audio format information comprises:
detecting the type of the input signal source through an audio system interface, wherein the type of the input signal source comprises at least one of Bluetooth, Wi-Fi, or wired interface;
parsing an audio format of the input signal source; wherein the audio format comprises at least one of MP3, WAV, FLAC, and AAC; and
identifying a sampling rate and a bit depth of the input signal source to obtain the audio format information.

11. The electronic device according to claim 8, wherein in the audio system parameter configuration method, the identifying the audio content type and determining the optimal playback mode based on the type of the input signal source and the audio format information comprises:
querying, based on the type of the input signal source and the audio format information, a corresponding audio content type in a database;
calculating, according to hardware performance of the audio system, a current environmental condition, and a user historical preference, a matching score for each playback mode corresponding to the audio content type; and
selecting a playback mode with a highest matching score as the optimal playback mode.

12. The electronic device according to claim 8, wherein in the audio system parameter configuration method, the adjusting the relative positions, the angles, and the spatial distribution of the speakers in the audio system according to the speaker layout optimization scheme comprises:
controlling an electric adjustment mechanism in the audio system to adjust the relative positions and the angles of the speakers according to the speaker layout optimization scheme;
determining whether the angle of each of the speakers is correctly adjusted by using an angle sensor; and
verifying whether adjusted spatial distribution of the speakers meets requirements of the speaker layout optimization scheme.

13. The electronic device according to claim 8, wherein in the audio system parameter configuration method, the performing the channel configuration based on the adjusted speaker layout and the optimal playback mode comprises:
determining, based on an acoustic requirement of the optimal playback mode, a correspondence between each sound element and an available audio channel; and
assigning, based on the adjusted speaker layout, an audio signal of each channel to a corresponding speaker.

14. The electronic device according to claim 8, wherein in the audio system parameter configuration method, the collecting the noise intensity value, the spatial reverberation parameter, and the ambient light intensity data of the current environment to generate the environmental feature vector comprises:
collecting, using the environmental sensor, the noise intensity value, the spatial reverberation parameter, and the ambient light intensity data of the current environment; and
inputting the noise intensity value, the spatial reverberation parameter, and the ambient light intensity data of the current environment into a predefined environmental analysis model to obtain the environmental feature vector; wherein the predefined environmental analysis model is a multimodal data fusion-based machine learning model, wherein the multimodal data fusion-based machine learning model outputs a normalized environmental feature vector through jointly learning a nonlinear mapping relationship among the noise intensity, the spatial reverberation, and the light intensity.

15. The computer readable storage medium according to claim 9, wherein in the audio system parameter configuration method, the obtaining the type of the input signal source and the audio format information comprises:
detecting the type of the input signal source through an audio system interface, wherein the type of the input signal source comprises at least one of Bluetooth, Wi-Fi, or wired interface;
parsing an audio format of the input signal source; wherein the audio format comprises at least one of MP3, WAV, FLAC, and AAC; and
identifying a sampling rate and a bit depth of the input signal source to obtain the audio format information.

16. The computer readable storage medium according to claim 9, wherein in the audio system parameter configuration method, the identifying the audio content type and determining the optimal playback mode based on the type of the input signal source and the audio format information comprises:
querying, based on the type of the input signal source and the audio format information, a corresponding audio content type in a database;
calculating, according to hardware performance of the audio system, a current environmental condition, and a user historical preference, a matching score for each playback mode corresponding to the audio content type; and
selecting a playback mode with a highest matching score as the optimal playback mode.

17. The computer readable storage medium according to claim 9, wherein in the audio system parameter configuration method, the adjusting the relative positions, the angles, and the spatial distribution of the speakers in the audio system according to the speaker layout optimization scheme comprises:
controlling an electric adjustment mechanism in the audio system to adjust the relative positions and the angles of the speakers according to the speaker layout optimization scheme;
determining whether the angle of each of the speakers is correctly adjusted by using an angle sensor; and
verifying whether adjusted spatial distribution of the speakers meets requirements of the speaker layout optimization scheme.

18. The computer readable storage medium according to claim 9, wherein in the audio system parameter configuration method, the performing the channel configuration based on the adjusted speaker layout and the optimal playback mode comprises:
determining, based on an acoustic requirement of the optimal playback mode, a correspondence between each sound element and an available audio channel; and
assigning, based on the adjusted speaker layout, an audio signal of each channel to a corresponding speaker.

19. The computer readable storage medium according to claim 9, wherein in the audio system parameter configuration method, the collecting the noise intensity value, the spatial reverberation parameter, and the ambient light intensity data of the current environment to generate the environmental feature vector comprises:
collecting, using the environmental sensor, the noise intensity value, the spatial reverberation parameter, and the ambient light intensity data of the current environment; and
inputting the noise intensity value, the spatial reverberation parameter, and the ambient light intensity data of the current environment into a predefined environmental analysis model to obtain the environmental feature vector; wherein the predefined environmental analysis model is a multimodal data fusion-based machine learning model, wherein the multimodal data fusion-based machine learning model outputs a normalized environmental feature vector through jointly learning a nonlinear mapping relationship among the noise intensity, the spatial reverberation, and the light intensity.
